(19) United States
(12) Patent Application Publication
(10) Pub. No.: US 2025/0322250 A1
(43) Pub. Date: Oct. 16, 2025

(54) METHOD OF TRAINING MACHINE LEARING MODEL FOR MANAGING PROMPTS

(71) Applicant: International Business Machines Corporation, Armonk, NY (US)

(72) Inventors: Ashlesha Akella, Bangalore (IN); Brijkumar Chavda, Bangalore (IN); Akshar Kaul, Bangalore (IN); Shramona Chakraborty, Howrah (IN); Hima Patel, Bengaluru (IN); Nitin Gupta, Saharanpur (IN)

(21) Appl. No.: 18/636,481

(22) Filed: Apr. 16, 2024

(51) Int. Cl. G06N 3/091

(52) U.S. Cl. CPC G06N 3/091

(57) ABSTRACT

A computer-implemented method for training a machine learning model for managing prompt. A processor set determines patterns of data in a sample dataset to identify representative data from the sample dataset. The processor set combines the representative data with context for a number of tasks to generate a number of simple prompts. Each simple prompt comprises a portion of the representative data and context for a task from the number of tasks. The processor set trains the machine learning model using a training dataset comprises the number of simple prompts. The machine learning model is trained to identify priorities of words in the number of simple prompts.

### BACKGROUND

The disclosure relates generally to computational model construction and more specifically to constructing a computational model for managing prompts to manage data.

Large language models are computational systems engineered to comprehend and generate human-like text. Large language models are trained using huge amount of data containing billions or trillions of words using large amounts of parameters. The extensive data and parameterization empower the large language models to capture a broad range of linguistic nuances and complexities, thereby achieving significant improvement in performance across a diverse range of natural language processing tasks.

Through training, large language models can analyze extensive volumes of text data including books, articles, and web content to identify statistical patterns and structures inherent in human language. As a result, the training process enables the large language model to generate coherent and contextually relevant text in response to inputs.

As depicted, large language models have shown capabilities across various natural language processing applications including language translation, text summarization, question answering, and sentiment analysis. In addition, large language models can also perform data preparation tasks such as cleaning, collecting, and transformation of data.

### SUMMARY

According to one illustrative embodiment, a computer-implemented method for training a machine learning model for managing prompts is provided. A processor set determines patterns of data in a sample dataset to identify representative data from the sample dataset. The processor set combines the representative data with words for a number of tasks to generate a number of simple prompts. Each simple prompt comprises a portion of the representative data and words for a task from the number of tasks. The processor set trains the machine learning model using a training dataset comprises the number of simple prompts. The machine learning model is trained to identify priorities of words in the number of simple prompts. According to other illustrative embodiments, a computer system, and a computer program product for training a machine learning model for managing prompts are provided.

### BRIEF DESCRIPTION OF THE DRAWINGS

FIG. 1 is a pictorial representation of a computing environment in which illustrative embodiments may be implemented;

FIG. 2 is an illustration of a block diagram of a model management environment in accordance with an illustrative embodiment;

FIG. 3 is an illustration of a neural network in accordance with an illustrative embodiment;

FIG. 4 is a flowchart of a process for training a machine learning model for managing prompts in accordance with an illustrative embodiment;

FIG. 5 is a flowchart of a process for modifying an input prompt in accordance with an illustrative embodiment;

FIG. 6 is a flowchart of a process for determining patterns of data in accordance with an illustrative embodiment;

FIG. 7 is a flowchart of a process for training a machine learning model in accordance with an illustrative embodiment;

FIG. 8 is a flowchart of a process for generating context vectors in accordance with an illustrative embodiment;

FIG. 9 is a flowchart of a process for generating output using a foundation model in accordance with an illustrative embodiment;

FIG. 10 is a flowchart of a process for adjusting parameters for the machine learning model in accordance with an illustrative embodiment;

FIG. 11 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

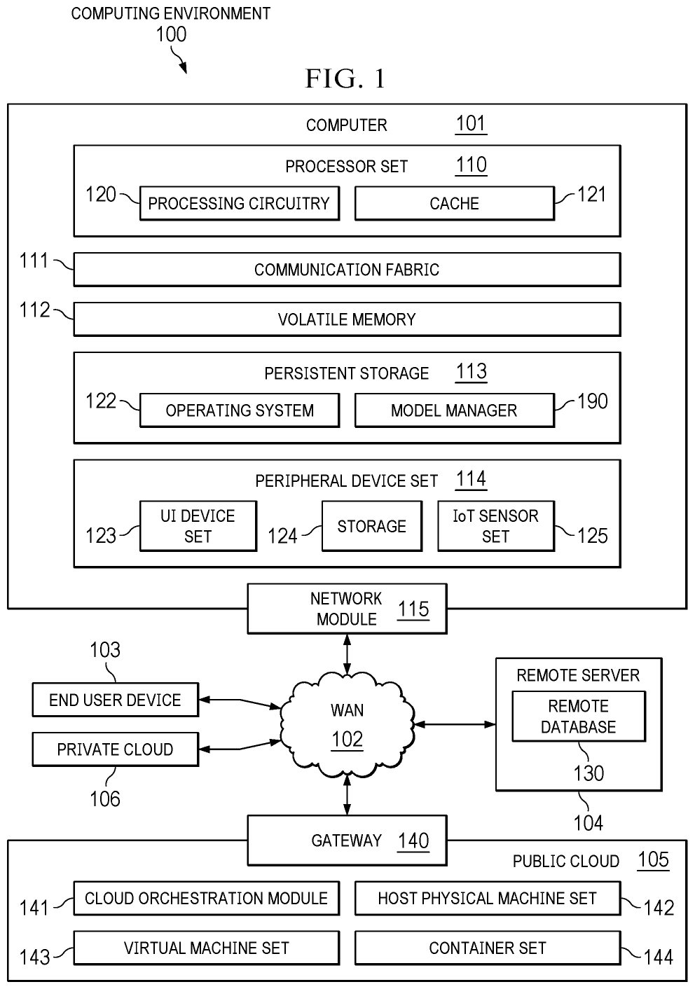

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as model manager 190. In addition to model manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and model manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in model manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in model manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display or otherwise present the recommendation to an end user. In some embodiments, EUD 103 may be a client device, such as a thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers such as computer 101. For example, in a hypothetical case where computer 101 is designed and programmed to provide a recommendation based on historical data, this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that automatic data preparation can significantly reduce the time required to clean and pre-process data. The illustrative embodiments also recognize and take into account that large language models (LLMs) have the potential to generate text that is relevant and coherent, but without proper guidance, LLMs can also produce irrelevant or even harmful responses.

The illustrative embodiments also recognize and take into account that it takes lots of manual effort to carefully craft prompts for LLMs to perform tasks on given data. However, the illustrative embodiments also recognize and take into account that appropriate prompts can guide LLMs to perform task with increased efficiency and accuracy.

Thus, illustrative embodiments of the present invention provide a computer implemented method, computer system, and computer program product for training a machine learning model for managing prompts. In one illustrative example, a computer implemented method trains a machine learning model. A processor set determines patterns of data in a sample dataset to identify representative data from the sample dataset. The processor set combines the representative data with words for a number of tasks to generate a number of simple prompts. The processor set trains the machine learning model using a training dataset comprises the number of simple prompts.

As used in herein, a “number of” when used with reference to items means one or more items. For example, a number of processor units is one or more processors.

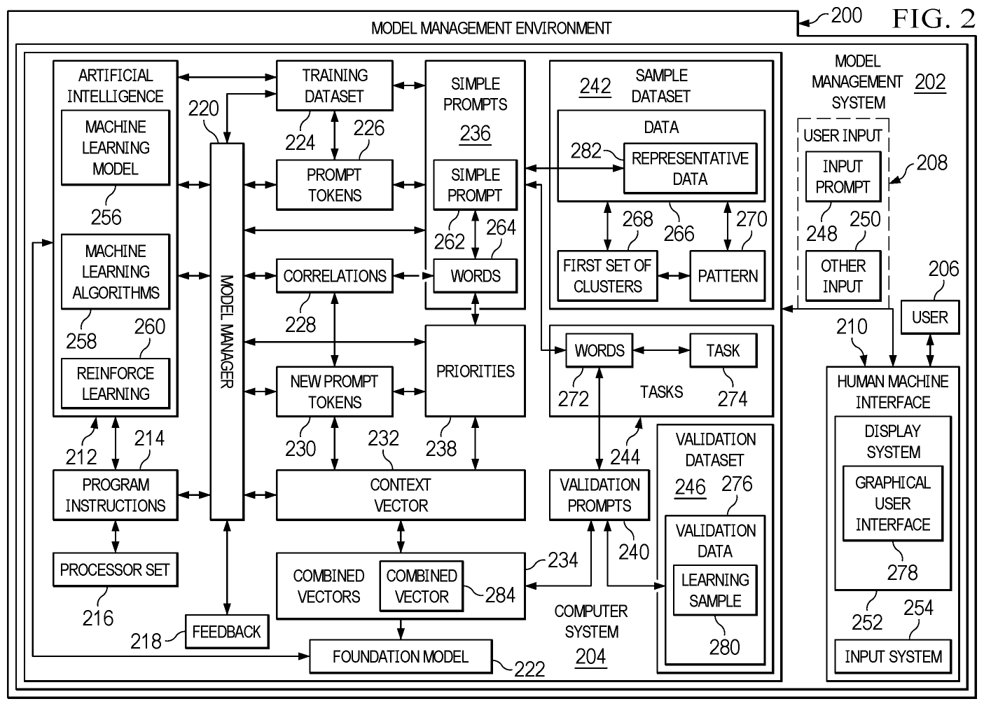

With reference now to FIG. 2, an illustration of a block diagram of a model management environment is depicted in accordance with an illustrative embodiment. In this illustrative example, model management environment 200 includes components that can be implemented in hardware such as the hardware shown in computing environment 100 in FIG. 1.

In this illustrative example, model management system 202 in model management environment 200 manages computational models such as machine learning models that can be used for generating and modifying input prompts to foundation models. In this illustrative example, foundation models are pre-trained general purpose models that can be used for performing tasks for data. In this illustrative example, model management system 202 includes computer system 204 and model manager 220. Model manager 220 is located in computer system 204. Model manager 220 may be implemented using model manager 190 in FIG. 1.

Model manager 220 can be implemented in software, hardware, firmware, or a combination thereof. When software is used, the operations performed by model manager 220 can be implemented in program instructions configured to run on hardware, such as a processor unit. When firmware is used, the operations performed by model manager 220 can be implemented in program instructions and data and stored in persistent memory to run on a processor unit. When hardware is employed, the hardware can include circuits that operate to perform the operations in model manager 220.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, computer system 204 includes sample dataset 242. Sample dataset 242 includes data 266. In this example, data 266 can be organized in a number of formats such as tabular formats, hierarchical formats, graph formats, or any suitable format for data organization.

Model manager 220 can perform clustering for data 266 to identify first set of clusters 268. Subsequently, model manager 220 identifies pattern 270 for data 266 based on first set of clusters 268. In this illustrative example, pattern 270 can be regularities, trends, relationships, underlying structures, and dependencies within data 266. In addition, model manager 220 identifies representative data 282 from data 266 based on pattern 270. In this illustrative example, representative data 282 is a subset of data 266 that accurately reflects characteristics and patterns of data 266.

For example, model manager 220 can perform clustering for tabular data in data 266 based on characteristics of the words in column values. In this illustrative example, the columns in the tabular data in data 266 form a table listing electronic products with columns for name, description, manufacturer, and price. As a result, model manager 220 can cluster columns in the tabular data based on semantic similarity among values in each column of the tabular data. In this example, the resulted clusters can be an example of first set of clusters 268. In this illustrative example, if semantic similarity among product names outweighs the similarity between descriptions and prices, the names of electronic items will form tighter clusters compared to the clusters formed by descriptions and prices.

In this illustrative example, model manager 220 can further identify pattern for the tabular data based on the resulted clusters. Pattern for the tabular data can be identified in a number of ways, for example, model manager 220 can identify centroids for each cluster from the resulted clusters. In this illustrative example, the centroids for the resulted clusters can be an example of pattern 270. Further, each centroid for each cluster corresponds to a value in a column of tabular data and rows that contain the value corresponds to each centroid can be selected as representative data 282.

Model manager 220 uses representative data 282 from data 266 to generate simple prompts 236 for training machine learning models. Simple prompts 236 are instructions or cues that can be used as input to initiate text generation or tasks for a large language model. In this illustrative example, simple prompts 236 are generated by combining representative data 282 with words 272 from tasks 244.

In this illustrative example, tasks 244 are activities or operations that can be performed for data. For example, tasks 244 can be data preparation tasks that include data collection, data cleaning, data transformation, data exploration, or data quality enhancement tasks such as data imputation, error detection, entity matching, programming by example, or any suitable activities or operations that can be performed for data to achieve a goal or an objective.

For example, simple prompt 262 from simple prompts 236 can be generated by combining words for task 274 from words 272 with a portion of representative data 282 from data 266. As depicted, a portion of representative data 282 can be a row of data from data 266 and task 274 can be a data quality enhancement task such as error detection. In this illustrative example, the portion of representative data 282 can be information for an electronic item such as {‘name’: [Linksys EtherFast EZXS88 W Ethernet SwitchEZXS88 W, Tripp Lite Power Verter 375-Watt Ultra-Compact Inverter-PV375, Sony Notebook and AC Adapter Cases-VGPAMC3], ‘description’: [‘Linksys EtherFast 8-Port 10/100 Switch (New/Workgroup)’, ‘Input Voltage: 12V DC-Output Voltage: 120V AC-375 W Pulse-width Modulated Sine Wave’, VAIO NEOPRENE NOTEBOOK & AC ADAPTER CASE UP TO 17 IN LCD]} and words for task 274 can be “error detection in description column”.

As a result, simple prompt 262 can be “error detection in description column+{‘name’: [Linksys EtherFast EZXS88 W Ethernet SwitchEZXS88 W, Tripp Lite Power Verter 375-Watt Ultra-Compact Inverter-PV375, Sony Notebook and AC Adapter Cases-VGPAMC3], ‘description’: [‘Linksys EtherFast 8-Port 10/100 Switch (New/Workgroup)’, ‘Input Voltage: 12V DC-Output Voltage: 120V AC-375 W Pulse-width Modulated Sine Wave’, VAIO NEOPRENE NOTEBOOK & AC ADAPTER CASE UP TO 17 IN LCD]}”.

In this example, simple prompt 262 can be used as an input to a large language model such that the large language model can be instructed to detect error in “description column” for the given information associated with the electronic item.

Model manager 220 can generate prompt tokens 226 based on words 264 for simple prompts 236. Prompt tokens 226 are units of text that are segmented from a larger body of text. In this illustrative example, multiple prompt tokens are generated for each simple prompt in simple prompts 236 and each prompt token in prompt tokens 226 represents one full word or part of a word from words 264 for simple prompts 236.

In this illustrative example, prompt tokens 226 forms training dataset 224 for training machine learning model 256 in artificial intelligence 212 to generate or modify input prompts. As depicted, artificial intelligence 212 can include machine learning model 256 and machine learning algorithms 258. Machine learning is a branch of artificial intelligence (AI) that enables computers to detect patterns and improve performance without direct programming commands. Rather than relying on direct input commands to complete a task, machine learning relies on input data. The data is fed into the machine, one of machine learning algorithms 258 is selected, parameters for the data are configured, and the machine is instructed to find patterns in the input data through optimization algorithms. The data model formed from analyzing the data is then used to predict future values. In this illustrative example, the learning of machine learning models 256 can be achieved by using input and feedbacks such that parameters for machine learning model 256 continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching for machine learning models 256. In this illustrative example, prompt tokens 226 in training dataset 224 can be converted to numerical vectors for training machine learning model 256.

In addition, artificial intelligence 212 can also include deep learning and deep learning algorithms. Deep learning is a method of artificial intelligence that mimics the human brain's capacity to learn and adapt. Deep learning utilizes neural networks that have multiple layers for identifying and learning features from data. In this illustrative example, deep learning can use an iterative process such as backpropagation and gradient descent to refine its parameters to make accurate predictions by minimizing the difference between outputs and actual results.

Artificial intelligence 212 can be implemented using one or more systems such as an artificial intelligence system, a neural network such as a transformer, a generative neural network, a Bayesian network, an expert system, a fuzzy logic system, a genetic algorithm, or other suitable types of systems. Machine learning model 256 and machine learning algorithms 258 may make computer system 204 a special purpose computer for generating or modifying input prompts.

Machine learning model 256 involves using machine learning algorithms 258 to build artificial intelligence 212 based on samples of data such as training dataset 224. In other words, machine learning models 256 are trained using training dataset 224. In this illustrative example, artificial intelligence 212 can make predictions without being explicitly programmed to make these predictions after training. Artificial intelligence 212 can also be trained and retrained for a number of different types of applications. These applications include, for example, medicine, financial services, healthcare, speech recognition, computer vision, or other types of applications.

Machine learning algorithms 258 can include supervised machine learning algorithms, unsupervised machine learning algorithms, and self-learning algorithms for deep learnings. Supervised machine learning can train machine learning models using data containing both the inputs and desired outputs. Examples of machine learning algorithms include XGBoost, K-means clustering, and random forest.

As depicted, machine learning model 256 is trained to generate or modify input prompts. In this illustrative example, machine learning model 256 can be trained using training dataset 224 such that machine learning model 256 is capable to identify correlations 228 between words in words 264 for simple prompts 236. Correlations 228 are dependencies and syntactic relationships that exist between words in words 264 for simple prompts 236. In this example, correlations 228 capture the grammatical structure of words 264 and how words in words 264 represent how words in words 264 relate to each other in terms of their roles, functions, and dependencies within prompts.

In this illustrative example, model manager 220 uses machine learning model 256 to identify priorities 238 for words 264 for simple prompts 236 based on correlations 228. Priorities 238 are information that represents relative importance of individual words or portions of words among words 264 for simple prompts 236. In this illustrative example, identifying priorities 238 for words 264 helps computer system 204 to better understand and extract meaning from human language because certain words carry more weight and significance in conveying overall message or intent of a text. In addition, computer system 204 can focus computational resources on the most relevant linguistic elements, therefore improving accuracy and efficiency of various language processing tasks.

In this illustrative example, model manager 220 can also use machine learning model 256 to generate new prompt tokens 230. New prompt tokens 230 are updated version of prompt tokens 226 with emphasis on dependencies and priorities for words. In other words, new prompt tokens 230 can be generated based on correlations 228 and priorities 238 for words 264. In this illustrative example, new prompt tokens 230 can be in the form of numerical vectors.

In this illustrative example, model manager 220 combines all tokens in new prompt tokens 230 to generate context vector 232. Context vector 232 is a numerical vector that contains contextual information in numerical form. In other words, context vector 232 includes information associated with priorities of words, correlations between words, and patterns of words for words 264 in simple prompts 236.

In this illustrative example, context vector 232 can also include information associated with other input 250 from user input 208. For example, computer system 204 can receive a user input 208 from user 206. In this example, user input 208 can be generated by user 206 using human machine interface (HMI) 210. As depicted, human machine interface 210 includes display system 252 and input system 254. Display system 252 is a physical hardware system and includes one or more display devices on which graphical user interface 278 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 278 through user input 208 generated by input system 254. Input system 254 is a physical hardware system and can be selected from at least one of a mouse, a keyboard, a touch pad, a trackball, a touchscreen, a stylus, a motion sensing input device, a gesture detection device, a data glove, a cyber glove a haptic feedback device, or some other suitable type of input device.

In one illustrative example, computer system 204 can receive input prompt 248 in user input 208 for performing a task in tasks 244 on additional data using a large language model. In this illustrative example, model manager 220 can use machine learning model 256 to modify input prompt 248 such that the large language model can better understand context and requests in input prompt 248, thereby improving the efficiency and accuracy of tasks performed for the additional data.

As depicted, artificial intelligence 212 can be improved using reinforce learning 260. Reinforce learning 260 is a type of machine learning framework that improves machine learning model 256 through trials and errors. For example, computer system 204 can include validation dataset 246 that contain validation data 276 for the purpose of improving machine learning model 256. In this illustrative example, validation data 276 are data for learning samples that can be used for improving machine learning model 256.

Validation dataset 246 can further include ground truths for the learning samples contained in validation data 276. In this illustrative example, ground truths are correct or expected outcome for learning samples contained in validation data 276. Ground truths can be used as reference or benchmark for evaluating performance of a model.

In this illustrative example, model manager 220 can generate validation prompts 240 using validation data 276 and words from words 272 for a task in task 274. In a similar fashion, validation prompts 240 are instructions or cues that can be used as input to initiate text generation or tasks for a large language model. In this illustrative example, validation prompts 240 are generated by combining validation data 276 and words from words 272 for a task in task 274. In this illustrative example, each validation prompt in validation prompts 240 corresponds to one learning sample in validation data 276 and can be converted to a numerical vector using an embedding layer from a foundation model.

Model manager 220 combines context vector 232 with validation prompts 240 to generate combined vectors 234. In this illustrative example, each combined vector in combined vectors 234 corresponds to a learning sample validation data. For example, combined vector 284 from combined vectors 234 can correspond to learning sample 280 in validation data 276.

In this illustrative example, combined vectors 234 can be used as inputs for foundation model 222. Foundation model 222 is a pre-trained machine learning model that can be used to perform various tasks upon receiving an input. In this example, combined vector 284 can be inputted into foundation model 222 such that foundation model 222 generates a prediction for learning sample 280.

In this illustrative example, model manager 220 compares the truth ground for the learning sample 280 with the prediction generated by foundation model 222 to determine if the prediction generated by foundation model 222 is accurate. In addition, model manager 220 generates feedback 218 based on the comparison and backpropagate feedback 218 to artificial intelligence 212 such that parameters in machine learning model 256 can be adjusted to improve quality of context vector 232 generated using machine learning model 256.

In this illustrative example, model manager 220 can input different learning samples into foundation model 222 and utilize reinforce learning 260 to improve machine learning model 256 and quality of context vector 232 until accuracy of prediction generated for a learning sample in validation data 276 exceeds a predefined threshold.

In one illustrative example, one or more solutions are present that overcome a problem with generating and modifying input prompts for large language models for performing tasks efficiently. As a result, one or more technical solutions may provide an ability to increase the efficiency and accuracy in performing tasks using large language models.

In the illustrative example, computer system 204 can be configured to perform at least one of the steps, operations, or actions described in the different illustrative examples using software, hardware, firmware, or a combination thereof. As a result, computer system 204 operates as a special purpose computer system in which model manager 220 in computer system 204 enables managing training of machine learning model 256, generation of training dataset 224, correlations 228, new prompt tokens 230, context vector 232, and combined vector. In particular, model manager 220 transforms computer system 204 into a special purpose computer system as compared to currently available general computer systems that do not have a model manager 220.

In the illustrative example, the use of model manager 220 in computer system 204 integrates processes into a practical application for managing machine learning model 256 that increases the performance of computer system 204. In other words, model manager 220 in computer system 204 is directed to a practical application of processes integrated into model manager 220 in computer system 204 that generates training dataset to train and improve a machine learning model for generating and modifying prompts for managing data. In this illustrative example, knowledge of which words should be prioritized in the prompt can help machine learning models to accurately capture context and meaning of what tasks should be performed and how to perform those tasks.

The illustration of model management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, the conversion of prompt tokens 226, new prompt tokens 230, and validation prompts 240 into numerical vectors can be performed based on embedding layers from a single foundation model or embedding layers from different foundation models.

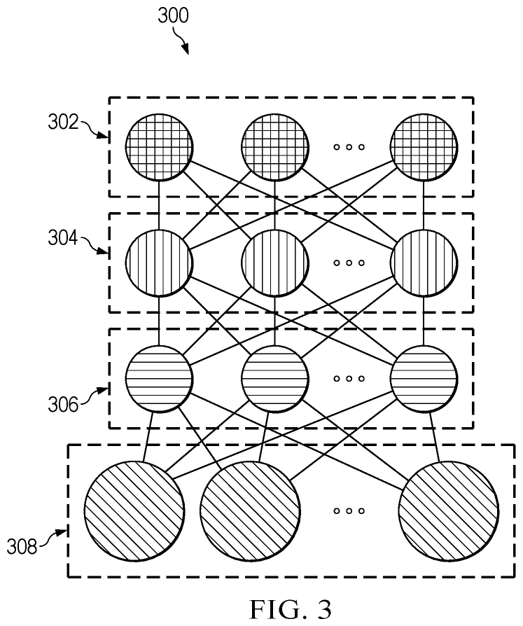

Turning next to FIG. 3, an illustration of a neural network is depicted in accordance with an illustrative embodiment. As depicted, neural network 300 includes multiple layers to perform different operations. In the illustrative examples, neural network 300 can be an example of machine learning model 256 in FIG. 2.

In FIG. 3, layer 308 can be an input layer. In this illustrative example, layer 308 includes prompt tokens such as prompt tokens 226 in FIG. 2 as inputs. Layer 308 does not perform any computations or transformations on the prompt tokens but rather pass the prompt tokens to subsequent layers in neural network 300. For example, layer 308 passes the prompt tokens to layer 306 for further processing. In this illustrative example, layer 306 can be an embedding layer that converts prompt tokens to numerical representations in the form of numerical vectors. In this illustrative example, the numerical representations for prompt tokens contain compressed information of prompt tokens. In this example, layer 306 can be a pre-trained embedding layer from a foundation model such as foundation model 222 in FIG. 2 or a different foundation model.

In addition, the numerical vectors from layer 306 are fed to layer 304 for further processing. In this illustrative example, layer 304 can be a multi-head attention layer that captures correlations and dependencies of prompt tokens through the numerical representations. Output from layer 304 is a latent representation in the form of numerical vector that includes all information associated with correlations and dependencies between prompts tokens. In this illustrative example, latent representation is a representation that captures important features or characteristic for data. Latent representation can also be referred to as “hidden representation” or “hidden numerical representation”.

In this illustrative example, the latent representation output by layer 304 is used as input to layer 302. Layer 302 in neural network 300 can be a feedforward layer that takes latent representations as input and applies linear transformation on the input latent representations. In other words, layer 302 is capable of learning pattern mapping and pattern association for input data. In this illustrative example, the feedforward layer enables neural network 300 to learn complicated relationships and patterns from prompt tokens input to layer 308.

In this illustrative example, complicated pattern and correlations between different words that are represented by prompt tokens can be learned by using different layers in neural network 300. For example, neural network 300 can be used to identify priorities of words that helps a large language model to better understand input prompts under a given context.

The illustration of neural network 300 in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, additional layers such as a positional encoding layer can be added to neural network 300. In this illustrative example, the positional encoding layer adds different positional information to different prompt tokens such that neural network 300 can be modeled to distinguish important input data from irrelevant input data.

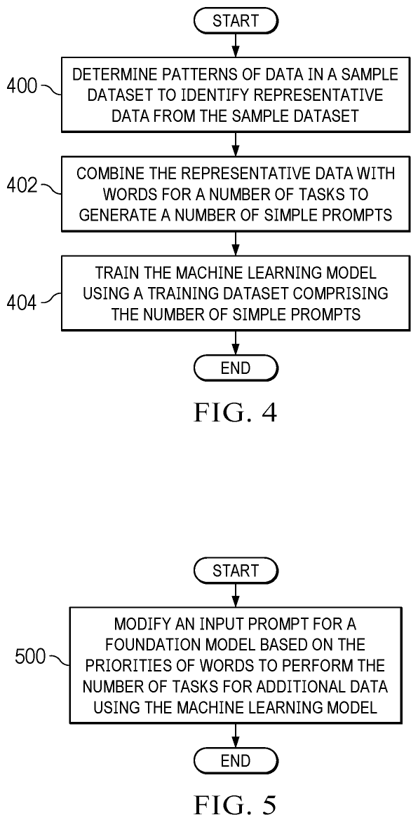

With reference now to FIG. 4, a flowchart illustrating a process for training a machine learning model for managing prompt is shown in accordance with an illustrative embodiment. The process in FIG. 4 can be implemented in hardware, software, or both. When implemented in software, the process can take the form of program instructions that are run by one of more processor units located in one or more hardware devices in one or more computer systems. For example, the process can be implemented in model manager 220 in computer system 204 in FIG. 2.

The process begins by determining patterns of data in a sample dataset to identify representative data from the sample dataset (step 400). The process combines the representative data with words for a number of tasks to generate a number of simple prompts (step 402). In step 402, each simple prompt in the number of simple prompts comprises a portion of the representative data and words for a task from the number of tasks.

The process trains the machine learning model using a training dataset comprises the number of simple prompts (step 404). In step 404, the machine learning model is trained to identify priorities of words in the number of simple prompts. The process terminates thereafter.

Turning next to FIG. 5, a flowchart of a process for modifying an input prompt is depicted in accordance with an illustrative embodiment. The process in this figure is an example of an additional step that can be performed with the steps in FIG. 4.

The process begins by modifying an input prompt for a foundation model based on the priorities of words to perform the number of tasks for additional data using the machine learning model (step 500). The process terminates thereafter.

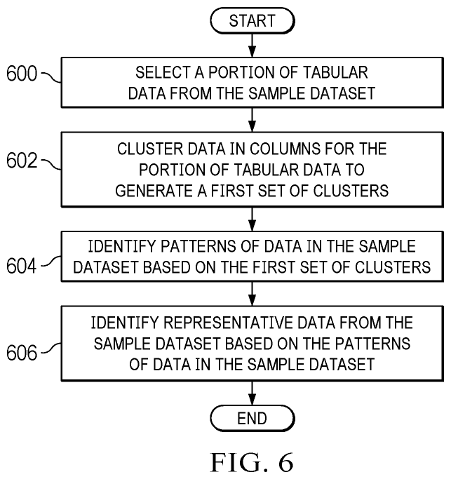

Turning next to FIG. 6, a flowchart of a process for determining patterns of data is depicted in accordance with an illustrative embodiment. The process in this flowchart is an example of an implementation for step 400 in FIG. 4.

The process begins by selecting a portion of tabular data from the sample dataset (step 600). In step 600, the portion of tabular data comprises no duplicated data. The process clusters data in columns for the portion of tabular data to generate a first set of clusters (step 602). The process identifies patterns of data in the sample dataset based on the first set of clusters (step 604). The process identifies representative data from the sample dataset based on the patterns of data in the sample dataset (step 606). The process terminates thereafter.

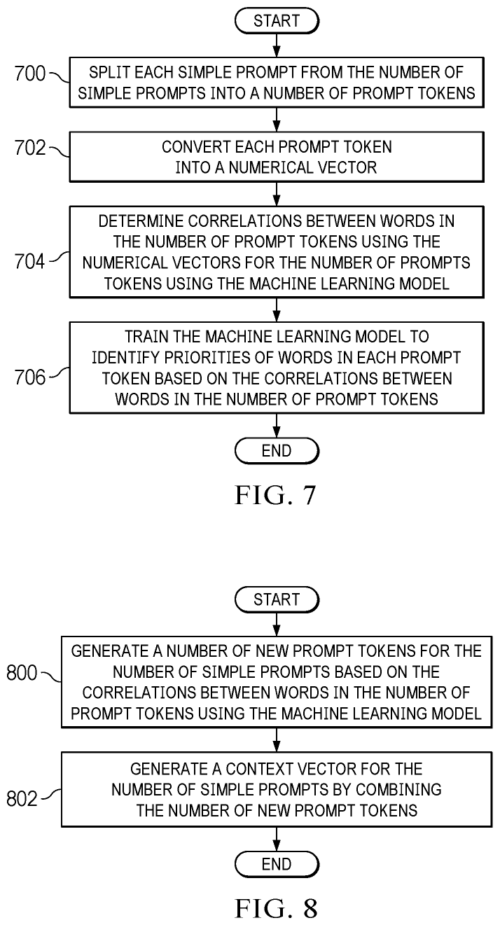

Turning next to FIG. 7, a flowchart of a process for training machine learning model is depicted in accordance with an illustrative embodiment. The process in this flowchart is an example of an implementation for step 404 in FIG. 4.

The process begins by splitting each simple prompt from the number of simple prompts into a number of prompt tokens (step 700). This tokenization process breaks down the texts in each simple prompt into units that can be words, subwords, or characters. In step 700, each prompt token in the number of prompt tokens includes a word or part of a word from a simple prompt from the number of simple prompts. The process converts each prompt token into a numerical vector (step 702). In step 702, the conversion of prompt tokens into numerical vectors can be performed using a vocabulary of tokens created based on texts in the prompt tokens. In this illustrative example, the prompt tokens can be mapped to the vocabulary and subsequently converted into numerical vectors using a pre-trained embedding matrix.

The process determines correlations between words in the number of prompt tokens using the numerical vectors for the number of prompts tokens using the machine learning model (step 704). The process trains the machine learning model to identify priorities of words in each prompt token based on the correlations between words in the number of prompt tokens (step 706). The process terminates thereafter.

Turning next to FIG. 8, a flowchart of a process for generating context vectors is depicted in accordance with an illustrative embodiment. The process in this figure is an example of an additional step that can be performed with the steps in FIG. 7.

The process begins by generating a number of new prompt tokens for the number of simple prompts based on the correlations between words in the number of prompt tokens using the machine learning model (step 800).

The process generates a context vector for the number of simple prompts by combining the number of new prompt tokens (step 802). In step 802, the context vector includes numerical representation for priority of words and pattern of words for all simple prompts in the number of simple prompts. The process terminates thereafter.

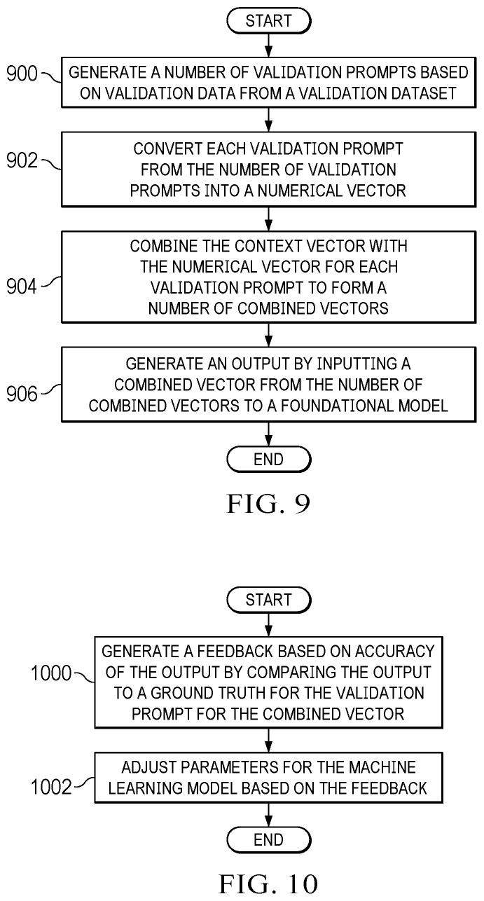

Turning next to FIG. 9, a flowchart of a process for generating output using a foundation model is depicted in accordance with an illustrative embodiment. The process in this figure is an example of an additional step that can be performed with the steps in FIG. 8.

The process begins by generating a number of validation prompts based on validation data from a validation dataset (step 900). In step 900, each validation prompt from the number of validation prompt includes a portion of the validation data and words for a task from the number of tasks. The process converts each validation prompt from the number of validation prompts into a numerical vector (step 902). In step 902, the conversion of validation prompts into numerical vectors can be performed using a vocabulary of validation prompts created based on texts in the validation prompts. In this illustrative example, the validation prompts can be mapped to the vocabulary and subsequently converted into numerical vectors using a pre-trained embedding matrix.

The process combines the context vector with the numerical vector for each validation prompt to form a number of combined vectors (step 904). The process generates an output by inputting a combined vector from the number of combined vectors to a foundation model (step 906). The process terminates thereafter.

Turning next to FIG. 10, a flowchart of a process for adjusting parameters for the machine learning model is depicted in accordance with an illustrative embodiment. The process in this figure is an example of an additional step that can be performed with the steps in FIG. 9.

The process begins by generating a feedback based on accuracy of the output by comparing the output to a ground truth for the validation prompt for the combined vector (step 1000). The process adjusts parameters for the machine learning model based on the feedback (step 1002). The process terminates thereafter.

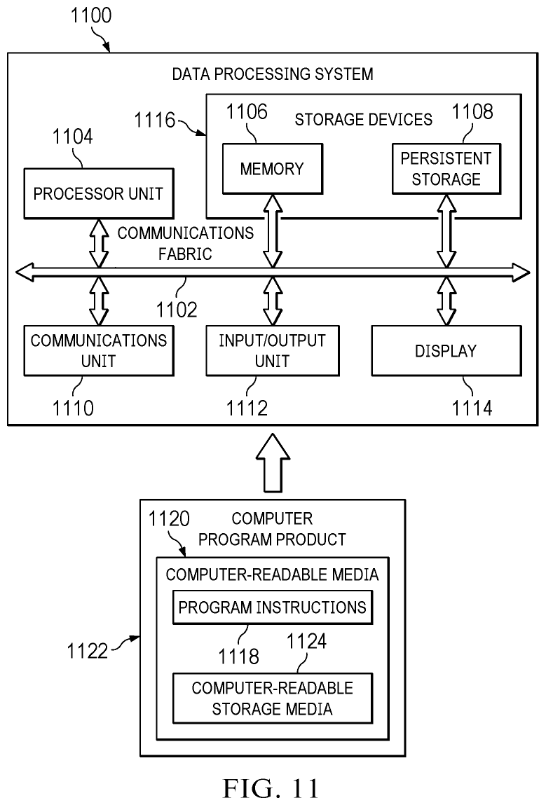

Turning now to FIG. 11, a block diagram of a data processing system is depicted in accordance with an illustrative embodiment. Data processing system 1100 can be used to implement computers and computing devices in computing environment 100 in FIG. 1. Data processing system 1100 can also be used to implement computer system 204 in FIG. 2. In this illustrative example, data processing system 1100 includes communications framework 1102, which provides communications between processor unit 1104, memory 1106, persistent storage 1108, communications unit 1110, input/output (I/O) unit 1112, and display 1114. In this example, communications framework 1102 takes the form of a bus system.

Processor unit 1104 serves to execute instructions for software that can be loaded into memory 1106. Processor unit 1104 includes one or more processors. For example, processor unit 1104 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1104 can be implemented using one or more heterogeneous processor systems in which a main processor is present with secondary processors on a single chip. As another illustrative example, processor unit 1104 can be a symmetric multi-processor system containing multiple processors of the same type on a single chip.

Memory 1106 and persistent storage 1108 are examples of storage devices 1116. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1116 may also be referred to as computer-readable storage devices in these illustrative examples. Memory 1106, in these examples, can be, for example, a random-access memory or any other suitable volatile or non-volatile storage device. Persistent storage 1108 may take various forms, depending on the particular implementation.

For example, persistent storage 1108 may contain one or more components or devices. For example, persistent storage 1108 can be a hard drive, a solid-state drive (SSD), a flash memory, a rewritable optical disk, a rewritable magnetic tape, or some combination of the above. The media used by persistent storage 1108 also can be removable. For example, a removable hard drive can be used for persistent storage 1108.

Communications unit 1110 in these illustrative examples provides for communications with other data processing systems or devices. In these illustrative examples, communications unit 1110 is a network interface card.

Input/output unit 1112 allows for input and output of data with other devices that can be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs can be located in storage devices 1116, which are in communication with processor unit 1104 through communications framework 1102. The processes of the different embodiments can be performed by processor unit 1104 using computer-implemented instructions, which may be located in a memory, such as memory 1106.

These instructions are referred to as program instructions, computer usable program instructions, or computer-readable program instructions that can be read and executed by a processor in processor unit 1104. The program instructions in the different embodiments can be embodied on different physical or computer-readable storage media, such as memory 1106 or persistent storage 1108.

Program instructions 1118 are located in a functional form on computer-readable media 1120 that is selectively removable and can be loaded onto or transferred to data processing system 1100 for execution by processor unit 1104. Program instructions 1118 and computer-readable media 1120 form computer program product 1122 in these illustrative examples. In the illustrative example, computer-readable media 1120 is computer-readable storage media 1124.

Computer-readable storage media 1124 is a physical or tangible storage device used to store program instructions 1118 rather than a medium that propagates or transmits program instructions 1118. Computer-readable storage media 1124 as used herein is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1118 can be transferred to data processing system 1100 using a computer-readable signal media. The computer-readable signal media are signals and can be, for example, a propagated data signal containing program instructions 1118. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1120” can be singular or plural. For example, program instructions 1118 can be located in computer-readable media 1120 in the form of a single storage device or system. In another example, program instructions 1118 can be located in computer-readable media 1120 that is distributed in multiple data processing systems. In other words, some instructions in program instructions 1118 can be located in one data processing system while other instructions in program instructions 1118 can be located in one data processing system. For example, a portion of program instructions 1118 can be located in computer-readable media 1120 in a server computer while another portion of program instructions 1118 can be located in computer-readable media 1120 located in a set of client computers. The different components illustrated for data processing system 1100 are not meant to provide architectural limitations to the manner in which different embodiments can be implemented. In some illustrative examples, one or more of the components may be incorporated in or otherwise form a portion of, another component. For example, memory 1106, or portions thereof, may be incorporated in processor unit 1104 in some illustrative examples. The different illustrative embodiments can be implemented in a data processing system including components in addition to or in place of those illustrated for data processing system 1100. Other components shown in FIG. 11 can be varied from the illustrative examples shown. The different embodiments can be implemented using any hardware device or system capable of running program instructions 1118.

Thus, illustrative embodiments of the present disclosure provide a computer-implemented method, computer system, and computer program product for managing machine learning models. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for training a machine learning model for managing prompts, the computer implemented method comprising:
determining, by a processor set, patterns of data in a sample dataset to identify representative data from the sample dataset;
combining, by the processor set, the representative data with words for a number of tasks to generate a number of simple prompts, wherein each simple prompt in the number of simple prompts comprises a portion of the representative data and words for a task from the number of tasks; and
training, by the processor set, the machine learning model using a training dataset comprising the number of simple prompts, wherein the machine learning model is trained to identify priorities of words in the number of simple prompts.

2. The computer implemented method of claim 1 further comprising:
modifying, by the processor set using the machine learning model, an input prompt for a foundation model based on the priorities of words to perform the number of tasks for additional data, wherein the foundation models is a pre-trained general purpose model that can be used for performing tasks for data.

3. The computer implemented method of claim 1, wherein determining, by a processor set, patterns of data in the sample dataset to identify representative data from the sample dataset comprises:
selecting, by the processor set, a portion of tabular data from the sample dataset, wherein the portion of tabular data comprises no duplicated data;
clustering, by the processor set, data in columns for the portion of tabular data to generate a first set of clusters;
identifying, by the processor set, patterns of data in the sample dataset based on the first set of clusters; and
identifying, by the processor set, representative data from the sample dataset based on the patterns of data in the sample dataset.

4. The computer implemented method of claim 1, wherein training, by the processor set, a machine learning model using a training dataset comprises the number of simple prompts comprises:
splitting, by the processor set, each simple prompt in the number of simple prompts into a number of prompt tokens, wherein each prompt token in the number of prompt tokens comprises a word or part of a word from a simple prompt from the number of simple prompts;
converting, by the processor set, each prompt token from the number of prompt tokens into a numerical vector;
determining, by the processor set using the machine learning model, correlations between words in the number of prompt tokens using the numerical vectors for the number of prompts tokens; and
training, by the processor set, the machine learning model to identify priorities of words in each prompt token based on the correlations between words in the number of prompt tokens.

5. The computer implemented method of claim 4 further comprising:
generating, by the processor set using the machine learning model, a number of new prompt tokens for the number of simple prompts based on the correlations between words in the number of prompt tokens using the machine learning model; and
generating, by the processor set, a context vector for the number of simple prompts by combining the number of new prompt tokens, wherein the context vector comprises numerical representation for priority of words and pattern of words for all simple prompts in the number of simple prompts.

6. The computer implemented method of claim 5 further comprising:
generating, by the processor set, a number of validation prompts based on validation data from a validation dataset, wherein each validation prompt from the number of validation prompts comprises a portion of the validation data and context for a task from the number of tasks;
converting, by the processor set, each validation prompt from the number of validation prompts into a numerical vector;
combining, by the processor set, the context vector with the numerical vector for each validation prompt to form a number of combined vectors; and
generating, by the processor set, an output by inputting a combined vector from the number of combined vectors to a foundation model.

7. The computer implemented method of claim 6 further comprising:
generating, by the processor set, a feedback based on accuracy for the output by comparing the output to a ground truth for the validation prompt for the combined vector; and
adjusting, by the processor set, parameters for the machine learning model based on the feedback.

8. A computer system comprising:
a processor set;
a set of one or more computer-readable storage media; and
program instructions, collectively stored in the set of one or more storage media, for causing the processor set to perform the following computer operations:
determine patterns of data in a sample dataset to identify representative data from the sample dataset;
combine the representative data with words for a number of tasks to generate a number of simple prompts, wherein each simple prompt in the number of simple prompts comprises a portion of the representative data and words for a task from the number of tasks; and
train a machine learning model using a training dataset comprising the number of simple prompts, wherein the machine learning model is trained to identify priorities of words in the number of simple prompts.

9. The computer system of claim 8, wherein the program instructions, collectively stored in the set of one or more storage media, further cause the processor set to perform the following computer operations:
modify an input prompt for a foundation model based on the priorities of words to perform the number of tasks for additional data using the machine learning model, wherein the foundation models are pre-trained general purpose models that can be used for performing tasks for data.

10. The computer system of claim 8, wherein as part of determining patterns of data in the sample dataset to identify representative data from the sample dataset, the program instructions, collectively stored in the set of one or more storage media, cause the processor set to perform the following computer operations:
select a portion of tabular data from the sample dataset, wherein the portion of tabular data comprises no duplicated data;
cluster data in columns for the portion of tabular data to generate a first set of clusters;
identify patterns of data in the sample dataset based on the first set of clusters; and
identify representative data from the sample dataset based on the patterns of data in the sample dataset.

11. The computer system of claim 8, wherein as part of training a machine learning model using a training dataset comprises the number of simple prompts, the program instructions, collectively stored in the set of one or more storage media, cause the processor set to perform the following computer operations:
split each simple prompt from the number of simple prompts into a number of prompt tokens, wherein each prompt token in the number of prompt tokens comprises a word or part of a word from a simple prompt from the number of simple prompts;
convert each prompt token from the number of prompt tokens into a numerical vector;
determine correlations between words in the number of prompt tokens using the numerical vectors for the number of prompts tokens using the machine learning model; and
train the machine learning model to identify priorities of words in each prompt token based on the correlations between words in the number of prompt tokens using the machine learning model.

12. The computer system of claim 11, wherein the program instructions, collectively stored in the set of one or more storage media, further cause the processor set to perform the following computer operations:
generate a number of new prompt tokens for the number of simple prompts based on the correlations between words in the number of prompt tokens using the machine learning model; and
generate a context vector for the number of simple prompts by combining the number of new prompt tokens, wherein the context vector comprises numerical representation for priority of words and pattern of words for all simple prompts in the number of simple prompts.

13. The computer system of claim 12, wherein the program instructions, collectively stored in the set of one or more storage media, further cause the processor set to perform the following computer operations:
generate a number of validation prompts based on validation data from a validation dataset, wherein each validation prompt from the number of validation prompts comprises a portion of the validation data and words for a task from the number of tasks;
convert each validation prompt from the number of validation prompts into a numerical vector;
combine the context vector with the numerical vector for each validation prompt to form a number of combined vectors; and
generate an output by inputting a combined vector from the number of combined vectors to a foundation model, wherein the foundation model is a pre-trained general purpose model that can be used for performing tasks for data.

14. The computer system of claim 13, wherein the program instructions, collectively stored in the set of one or more storage media, further cause the processor set to perform the following computer operations:
generate a feedback based on accuracy for the output by comparing the output to a ground truth for the validation prompt for the combined vector; and
adjust parameters for the machine learning model based on the feedback.

15. A computer program product for training a machine learning model for managing prompts, the computer program product comprising:
a set of one or more computer-readable storage media; and
program instructions, collectively stored in the set of one or more storage media, cause a processor set to perform the following computer operations:
determine patterns of data in a sample dataset to identify representative data from the sample dataset;
combine the representative data with words for a number of tasks to generate a number of simple prompts, wherein each simple prompt in the number of simple prompts comprises a portion of the representative data and words for a task from the number of tasks; and
train the machine learning model using a training dataset comprising the number of simple prompts, wherein the machine learning model is trained to identify priorities of words in the number of simple prompts.

16. The computer program product of claim 15, wherein program instructions, collectively stored in the set of one or more storage media further cause the processor set to:
modify an input prompt for a foundation model based on the priorities of words to perform the number of tasks for additional data using the machine learning model, wherein the foundation models are pre-trained general purpose models that can be used for performing tasks for data.

17. The computer program product of claim 15, wherein as part of determining patterns of data in the sample dataset to identify representative data from the sample dataset, the program instructions, collectively stored in the set of one or more storage media, the operation performed by the processor set comprises:
select a portion of tabular data from the sample dataset, wherein the portion of tabular data comprises no duplicated data;
cluster data in columns for the portion of tabular data to generate a first set of clusters;
identify patterns of data in the sample dataset based on the first set of clusters; and
identify representative data from the sample dataset based on the patterns of data in the sample dataset.

18. The computer program product of claim 15, wherein as part of training a machine learning model using a training dataset comprises the number of simple prompts, the program instructions, the operation performed by the processor set comprises:
split each simple prompt from the number of simple prompts into a number of prompt tokens, wherein each prompt token in the number of prompt tokens comprises a word or part of a word from a simple prompt from the number of simple prompts;
convert each prompt token from the number of prompt tokens into a numerical vector;
determine correlations between words in the number of prompt tokens using the numerical vectors for the number of prompts tokens using the machine learning model; and
train the machine learning model to identify priorities of words in each prompt token based on the correlations between words in the number of prompt tokens using the machine learning model.

19. The computer program product of claim 18, wherein program instructions, collectively stored in the set of one or more storage media further cause the processor set to:
generate a number of new prompt tokens for the number of simple prompts based on the correlations between words in the number of prompt tokens using the machine learning model; and
generate a context vector for the number of simple prompts by combining the number of new prompt tokens, wherein the context vector comprises numerical representation for priority of words and pattern of words for all simple prompts in the number of simple prompts.

20. The computer program product of claim 19, wherein program instructions, collectively stored in the set of one or more storage media further cause the processor set to:
generate a number of validation prompts based on validation data from a validation dataset, wherein each validation prompt from the number of validation prompts comprises a portion of the validation data and words for a task from the number of tasks;
convert each validation prompt from the number of validation prompts into a numerical vector;
combine the context vector with the numerical vector for each validation prompt to form a number of combined vectors; and
generate an output by inputting a combined vector from the number of combined vectors to a foundation model, wherein the foundation model is a pre-trained general purpose model that can be used for performing tasks for data.
